(19) United States
(12) Patent Application Publication
(10) Pub. No.: US 2018/0369073 A1
(43) Pub. Date: Dec. 27, 2018

(54) BABY BOTTLE HOLDER

(71) Applicant: Gianni Amadeo Deluca, North York (CA)

(72) Inventor: Gianni Amadeo Deluca, North York (CA)

(21) Appl. No.: 15/631,731

(22) Filed: Jun. 23, 2017

(51) Int. Cl. A61J 9/06; A47D 15/00

(52) U.S. Cl. CPC A61J 9/0638; A61J 9/0661; A61J 9/00; A61J 9/06; A47D 15/00

(57) ABSTRACT

An apparatus includes a baby bottle holder configured to support a baby bottle at a deployed position located proximate to a baby. The baby is able to reach the baby bottle in the deployed position. The baby is received and positioned in a movable baby carriage. The movable baby carriage has a carriage handle. The baby bottle holder is also configured to selectively attach to, and detach from, the carriage handle of the movable baby carriage at a storage position. The baby bottle holder, in use, remains positioned away from the reach of the baby who is positioned in the movable baby carriage once the baby bottle holder is selectively attached to the carriage handle of the movable baby carriage at the storage position.

### TECHNICAL FIELD

This document relates to the technical field of (and is not limited to) a baby bottle holder (and method therefor).

### BACKGROUND

Generally, baby bottle holders are configured to hold a baby bottle. The baby bottle is a bottle with a teat (also called a nipple) to assist in drinking directly from the bottle. It is typically used by infants and young children, or if someone cannot (conveniently) drink from a cup, for feeding oneself or being fed. In particular, it is used to feed infant formula, expressed breast milk or a pediatric electrolyte solution.

### SUMMARY

It will be appreciated that there exists a need to mitigate (at least in part) at least one problem associated with the existing baby bottle holders (also called the existing technology). After much study of the known systems and methods with experimentation, an understanding of the problem and its solution has been identified and is articulated as follows:

Known baby bottle holders are not generally convenient in that they are not selectively attachable to, and detachable from, a carriage handle of a baby carriage. Known baby bottle holders are not generally convenient in that they tend to remain positioned within reach of a baby positioned in a baby carriage when they are not required or being utilized. Known baby bottle holders are not convenient in that they are not conveniently storable at a convenient position (once the baby does not require feeding via the baby bottle).

It would be desirable to provide a baby bottle holder configured to selectively receive, at least in part, and support, at least in part, a baby bottle at a deployed position located proximate to a baby, in which the baby is able to reach the baby bottle in the deployed position, in which the baby is received and positioned in a movable baby carriage having a carriage handle.

It would also be desirable to have a baby bottle holder that is also configured to selectively attach to, and detach from, the carriage handle of the movable baby carriage at a storage position, in which the storage position is spaced apart from the deployed position.

It would be desirable to have a baby bottle holder that, in use, remains positioned away from the reach of the baby who is positioned in the movable baby carriage once the baby bottle holder is selectively attached to the carriage handle of the movable baby carriage at the storage position.

It would be an advantage to provide a baby bottle holder that is configured to be conveniently stored for the case where the baby does not require feeding via the baby bottle (while the baby bottle is supported by the baby bottle holder).

To mitigate, at least in part, at least one problem associated with the existing technology, there is provided (in accordance with a major aspect) an apparatus. The apparatus includes and is not limited to (comprises) a baby bottle holder configured to selectively receive, at least in part, and support, at least in part, a baby bottle at a deployed position located proximate to a baby, in which the baby is able to reach the baby bottle in the deployed position, in which the baby is received and positioned in a movable baby carriage, and in which the movable baby carriage has a carriage handle. The baby bottle holder is also configured to selectively attach to, and detach from, the carriage handle of the movable baby carriage at a storage position, in which the storage position is spaced apart from the deployed position. The baby bottle holder, in use, remains positioned away from the reach of the baby who is positioned in the movable baby carriage once the baby bottle holder is selectively attached to the carriage handle of the movable baby carriage at the storage position.

To mitigate, at least in part, at least one problem associated with the existing technology, there is provided (in accordance with a major aspect) an apparatus. The apparatus includes and is not limited to (comprises) a baby bottle holder, including a resiliently deformable body being configured to selectively receive, at least in part, and support, at least in part, a baby bottle at a deployed position located proximate to a baby, in which the baby is able to reach the baby bottle in the deployed position, in which the baby is received and positioned in a movable baby carriage, and in which the movable baby carriage has a carriage handle. The resiliently deformable body is also configured to selectively attach to, and detach from, the carriage handle of the movable baby carriage at a storage position, in which the storage position is spaced apart from the deployed position. The resiliently deformable body, in use, remains positioned away from the reach of the baby who is positioned in the movable baby carriage once the resiliently deformable body is selectively attached to the carriage handle of the movable baby carriage at the storage position.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIGS. 1 and 2 depict a side perspective view (FIG. 1) and a front perspective view (FIG. 2) of embodiments of a baby bottle holder, in which the baby bottle holder is placed in a deployed position; and

FIG. 3 depicts a side perspective view of an embodiment of the baby bottle holder of FIG. 1, in which the baby bottle holder is placed in a storage position; and

FIG. 4 depicts a backside perspective view of an embodiment of the baby bottle holder of FIG. 1; and

FIG. 5 depicts a front topside perspective view of an embodiment of the baby bottle holder of FIG. 1; and

FIG. 6 depicts a side perspective view of an embodiment of the baby bottle holder of FIG. 1; and

FIG. 7 depicts a topside perspective view of an embodiment of the baby bottle holder of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 baby bottle holder
104 resiliently deformable body
105 deployment position
106 first elongated channel
107 storage position
108 second elongated channel
109 end portion
900 baby
901 baby bottle cap
902 movable baby carriage
904 carriage handle
906 baby bottle

### DETAILED DESCRIPTION OF THE EXEMPLARY EMBODIMENTS

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the claim is defined by the claims (in which the claims may be amended during patent examination after filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

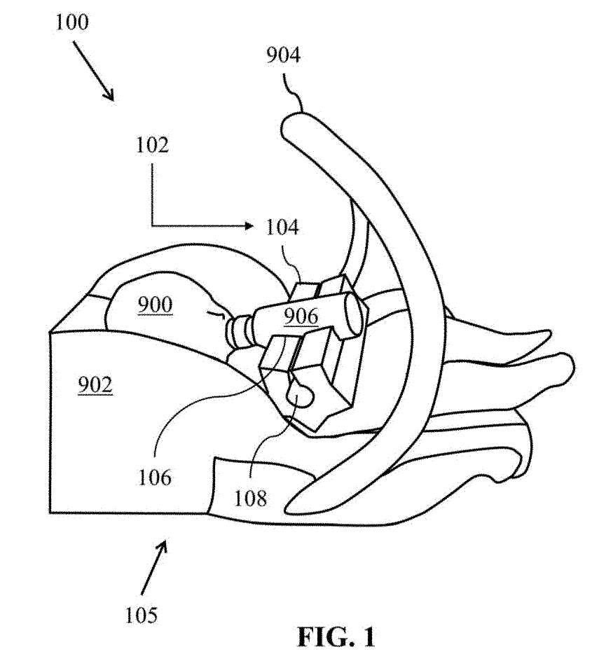

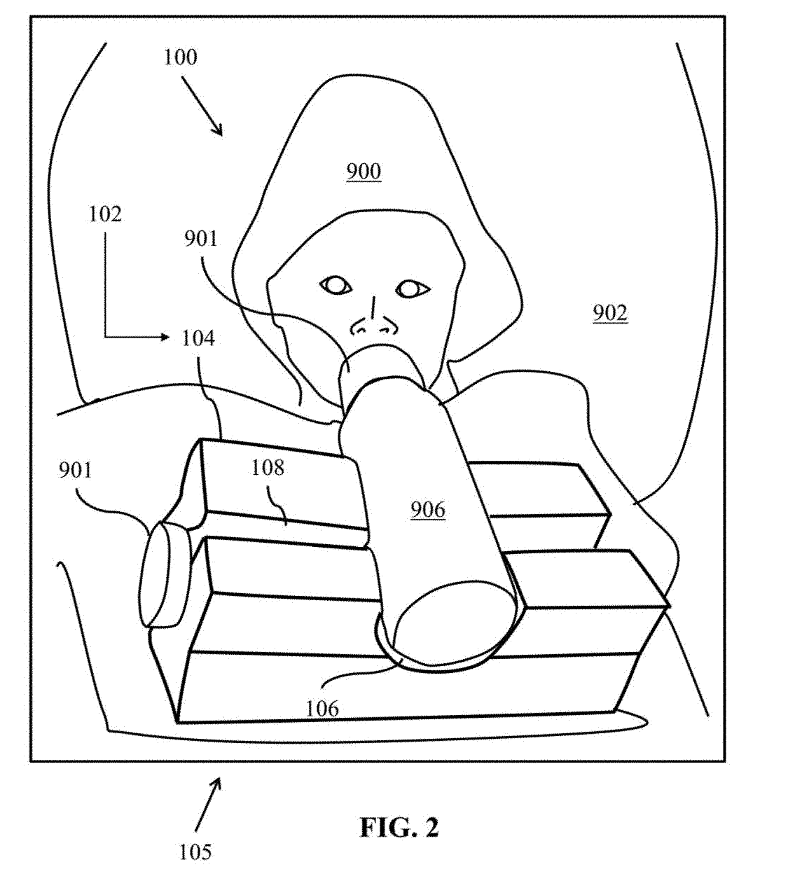

FIGS. 1 and 2 depict a side perspective view (FIG. 1) and a front perspective view (FIG. 2) of embodiments of a baby bottle holder 102 (in which the baby bottle holder 102 is placed in a deployed position 105).

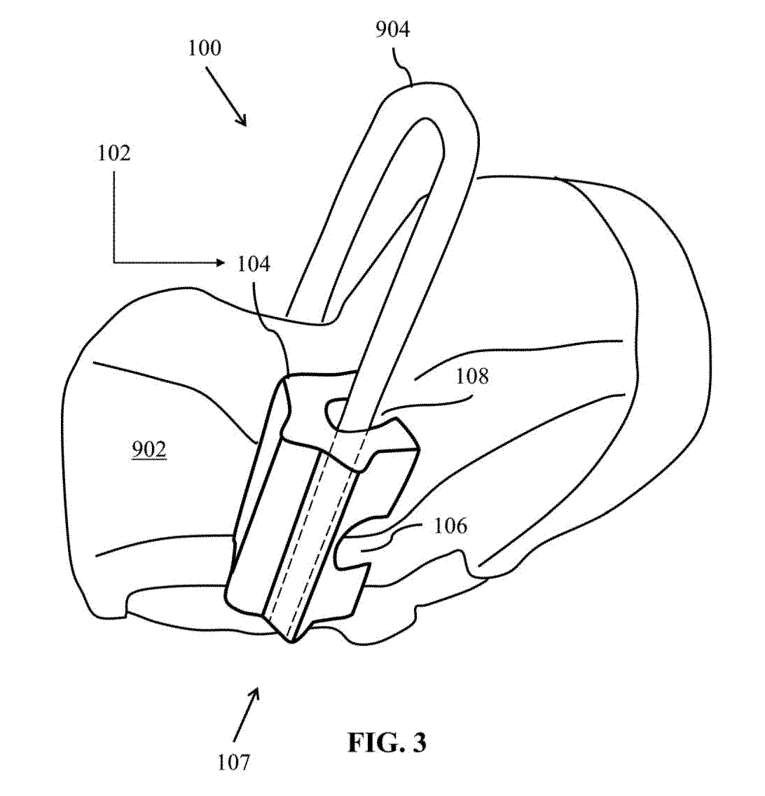

FIG. 3 depicts a side perspective view of an embodiment of the baby bottle holder 102 of FIG. 1 (in which the baby bottle holder 102 is placed in a storage position 107).

In accordance with a first major embodiment, there is provided an apparatus 100. The apparatus 100 includes a baby bottle holder 102 (and any equivalent thereof).

The baby bottle holder 102 may include, for instance, a collection of components, a collection of assemblies, a singular component, and/or a singular assembly (and any equivalent thereof). The baby bottle holder 102 is configured to selectively receive, at least in part, and support, at least in part, a baby bottle 906 at a deployed position 105. The baby bottle 906 may be called a nursing bottle. The deployed position 105 is located proximate to a baby 900 (preferably, located in front of the baby 900 and close to the mouth of the baby 900). Embodiments of the deployed position 105 are depicted in FIG. 1 and FIG. 2. The baby 900 is able to reach the baby bottle 906 in the deployed position 105. The baby 900 is received and positioned in a movable baby carriage 902 (hand held carry assembly and/or a baby stroller, etc., and any equivalent thereof). The movable baby carriage 902 has a carriage handle 904 (and any equivalent thereof).

The baby bottle holder 102 is also configured to selectively attach to, and selectively detach from, the carriage handle 904 of the movable baby carriage 902 at a storage position 107. An embodiment of the storage position 107 is depicted in FIG. 3. The storage position 107 is spaced apart from the deployed position 105. Preferably, the storage position 107 may be located on a side section of the movable baby carriage 902 (as depicted in FIG. 3), and the deployed position 105 is located in front of the baby 900 who is received in the movable baby carriage 902 (as depicted in FIG. 1 or FIG. 2).

The baby bottle holder 102, in use, remains positioned away from the reach of the baby 900 who is positioned in the movable baby carriage 902 once the baby bottle holder 102 is selectively attached to the carriage handle 904 of the movable baby carriage 902 at the storage position 107.

An advantage of the baby bottle holder 102 is that the baby bottle holder 102 is configured to be conveniently stored (when not utilized), for the case where the baby 900 does not require feeding via the baby bottle 906 while the baby bottle 906 is supported by the baby bottle holder 102.

In accordance with a second major embodiment, there is provided an apparatus 100. The apparatus 100 includes a baby bottle holder 102. The baby bottle holder 102 includes (and is not limited to) a resiliently deformable body 104. The resiliently deformable body 104 is a body or object having a material that is configured to (A) regain its original shape or position after being bent, stretched, compressed, or deformed (in other ways and means) once a deformation force is removed from the resiliently deformable body 104, and/or (B) change its shape and/or volume while being acted upon by an external force (deformation force).

The resiliently deformable body 104 is configured to selectively receive, at least in part, and support, at least in part, a baby bottle 906 at a deployed position 105. Embodiments of the deployed position 105 are depicted in FIG. 1 and FIG. 2, in which the deployed position 105 is located proximate to a baby 900 (preferably, in front of the baby). The baby 900 is able to reach the baby bottle 906 in the deployed position 105. In the deployed position 105, the baby bottle 906 is selectively received, at least in part, and supported, at least in part, by the resiliently deformable body 104. The baby 900 is received and positioned in a movable baby carriage 902. The movable baby carriage 902 has a carriage handle 904.

The resiliently deformable body 104 is also configured to selectively attach to, and detach from, the carriage handle 904 of the movable baby carriage 902 at a storage position 107 (as depicted in the embodiment of FIG. 3). The storage position 107 is spaced apart from the deployed position 105. Preferably, the storage position 107 is located on a side section of the movable baby carriage 902, and the deployed position 105 is located in front of the baby 900 who is received in the movable baby carriage 902.

The resiliently deformable body 104, in use, remains positioned away from the reach of the baby 900 who is positioned in the movable baby carriage 902 once the resiliently deformable body 104 is selectively attached to the carriage handle 904 of the movable baby carriage 902 at the storage position 107.

An advantage of the resiliently deformable body 104 is that the resiliently deformable body 104 provides, in use, convenient storage of the baby bottle holder 102 (for the case where the baby 900 does not require feeding via the baby bottle 906 with support from the resiliently deformable body 104).

In accordance with preferred embodiments, the resiliently deformable body 104 may include any one of (or combination of) the following: (A) a contoured, preformed, resilient solid body formed of a solid foam material or other foam material firm enough to provide support and to avoid any suffocation risk, (B) a preformed outer shell stuffed with a resilient material, (C) an inflatable component composed of a preformed, contoured outer shell that is inflated upon use (for instance, formed of vinyl, PVC (polyvinyl chloride), polyurethane, or other lightweight and rugged inflatable material), (D) a contoured generally tightfitting removable cover to allow convenient washing, (E) a removable cover tailored to fit the contours of the resiliently deformable body 104, (F) a foamed plastic or a flexible polyurethane foam, (G) a closed cell foam, (H) a polyurethane foam type of material, (I) a polymer cushioning, (J) a flexible polyurethane foam, (K) a closed cell foam, and any equivalent thereof.

In accordance with preferred embodiments, as depicted in FIG. 1 and FIG. 2, the resiliently deformable body 104 is further configured to provide (form) a first elongated channel 106. The first elongated channel 106 is configured to selectively receive, at least in part, the baby bottle 906 at the deployed position 105.

In accordance with preferred embodiments, as depicted in FIG. 1 and FIG. 2, the resiliently deformable body 104 is further configured to be resiliently deformable, at least in part, in such a way that: (A) the resiliently deformable body 104, in use, selectively frictionally receives, at least in part, the baby bottle 906, and (B) the resiliently deformable body 104, in use, positions the baby bottle 906 once the resiliently deformable body 104 is positioned proximate to the baby 900 who is positioned in the movable baby carriage 902 at the deployed position 105.

In accordance with a preferred embodiment, as depicted in FIG. 2, the resiliently deformable body 104 is further configured to securely receive, at least in part, a baby bottle cap 901 of the baby bottle 906. This arrangement provides a way for the selective secured attachment of the baby bottle cap 901 to the resiliently deformable body 104.

In accordance with a preferred embodiment, as depicted in FIG. 2, the resiliently deformable body 104 provides an end portion 109. The end portion 109 is configured to selectively receive, at least in part, a baby bottle cap 901. This arrangement provides safe and hygienic storage of the baby bottle cap 901 while the baby 900 is feeding from the baby bottle 906.

In accordance with a preferred embodiment, as depicted in FIG. 2, the resiliently deformable body 104 provides an end portion 109 configured to selectively receive, at least in part, and frictionally fit with, at least in part, a baby bottle cap 901.

In accordance with a preferred embodiment, as depicted in FIG. 2, the resiliently deformable body 104 is further configured to provide (form), at least in part, a second elongated channel 108. The second elongated channel 108 is configured to securely receive, at least in part, a baby bottle cap 901 of the baby bottle 906.

In accordance with a preferred embodiment, as depicted in FIG. 2, the resiliently deformable body 104 is further configured to provide (form), at least in part, a second elongated channel 108. The second elongated channel 108 is configured to friction fit, at least in part, with a baby bottle cap 901 of the baby bottle 906.

In accordance with preferred embodiments as depicted in FIGS. 1, 2 and 3, the resiliently deformable body 104 is further configured to provide (form) a first elongated channel 106. The first elongated channel 106 is configured to selectively receive, at least in part, the baby bottle 906 at the deployed position 105. The resiliently deformable body 104 is further configured to provide (form), at least in part, a second elongated channel 108 that is spaced apart from the first elongated channel 106. The second elongated channel 108 is configured to selectively frictionally attach, at least in part, to the carriage handle 904 of the movable baby carriage 902 at the storage position 107.

In accordance with a preferred embodiment, as depicted in FIG. 3, the resiliently deformable body 104 is further configured to provide (form), at least in part, a second elongated channel 108. The second elongated channel 108 is configured to selectively frictionally attach, at least in part, to the carriage handle 904 of the movable baby carriage 902 at the storage position 107.

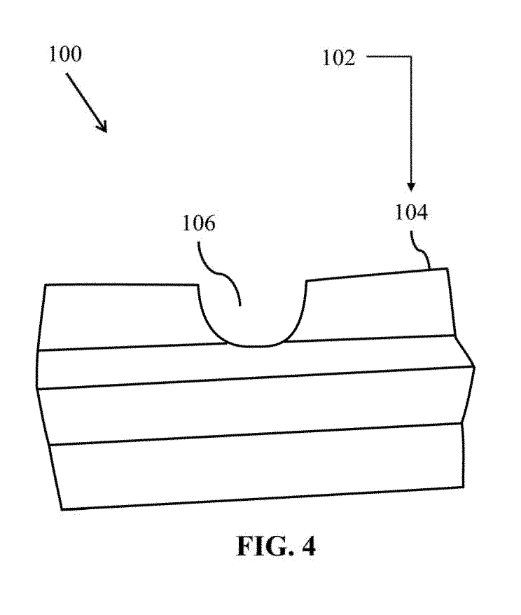

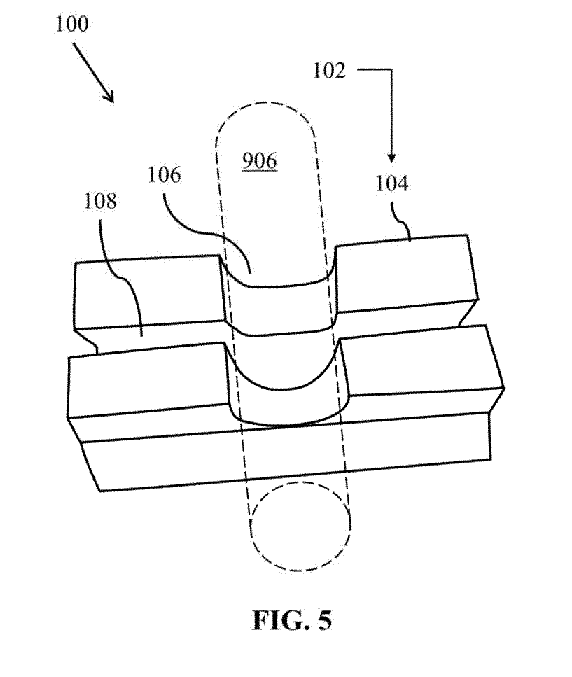

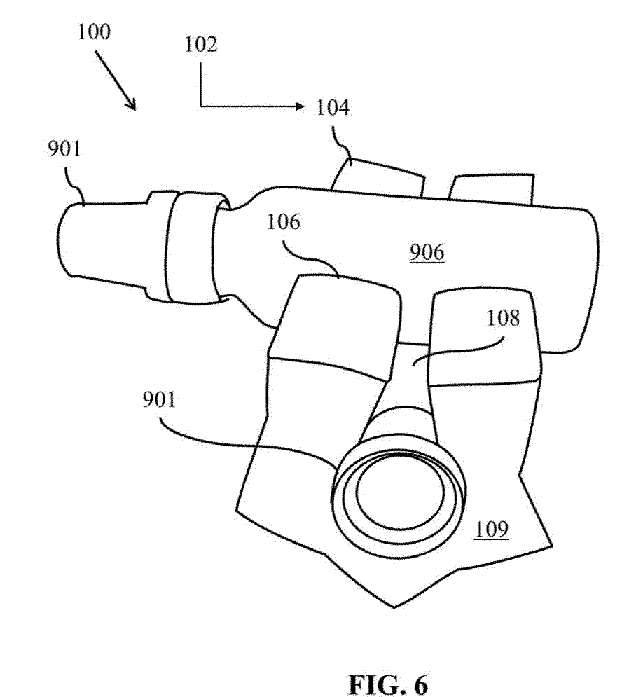

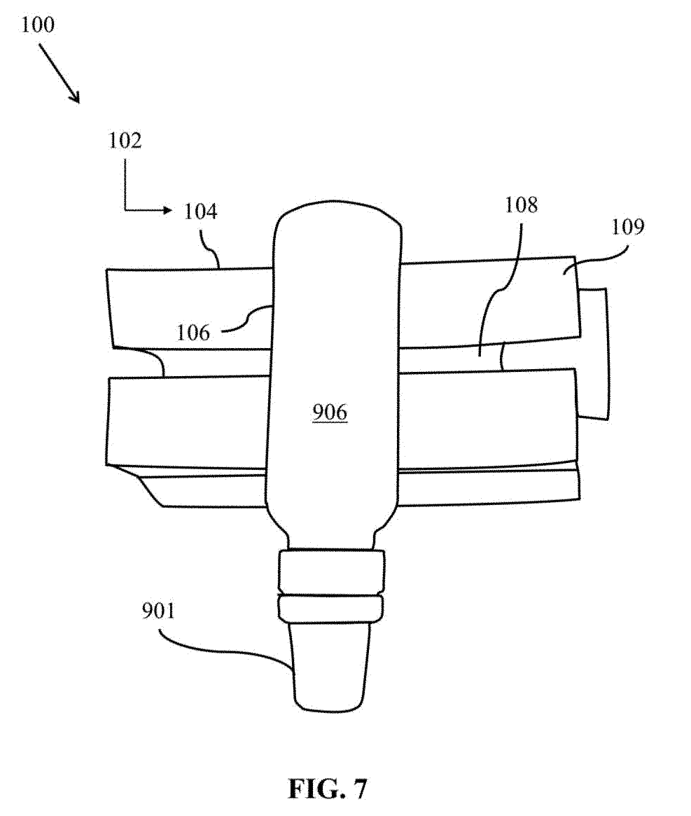

FIG. 4 depicts a backside perspective view of an embodiment of the baby bottle holder 102 of FIG. 1. FIG. 5 depicts a front topside perspective view of an embodiment of the baby bottle holder 102 of FIG. 1. FIG. 6 depicts a side perspective view of an embodiment of the baby bottle holder 102 of FIG. 1. FIG. 7 depicts a topside perspective view of an embodiment of the baby bottle holder 102 of FIG. 1.

Referring to the embodiments as depicted in FIGS. 4 to 7, the resiliently deformable body 104 has an elongated length extending between opposite side portions.

The first elongated channel 106 is positioned between the opposite side portions of the resiliently deformable body 104. Preferably, the first elongated channel 106 is positioned in the midsection of the resiliently deformable body 104. Preferably, the first elongated channel 106 forms a U-shaped formation having opposite side walls configured to engage (frictionally engage, selectively frictionally engage) the baby bottle 906 (as depicted in the embodiment of FIG. 2).

The baby bottle 906 may be inserted into the first elongated channel 106, and the opposite side walls (in use) resiliently spread apart and engage (frictionally engage) the baby bottle 906 in a secure manner (arrangement).

The second elongated channel 108 extends between the opposite side portions of the resiliently deformable body 104. Preferably, the second elongated channel 108 forms a U-shaped formation having opposite side walls configured to engage (frictionally engage, selectively frictionally engage) the baby bottle cap 901.

The first elongated channel 106 and the second elongated channel 108 intersect each other. Preferably, the first elongated channel 106 and the second elongated channel 108 are aligned orthogonally (90 degrees) relative to each other. The length of the first elongated channel 106 is shorter than the length of the second elongated channel 108.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus 100 (either explicitly or inherently). The apparatus 100 may include any suitable combination and/or permutation of the technical features as identified in the detailed description, as may be required and/or desired to suit a particular technical purpose and/or technical function. It will be appreciated that, where possible and suitable, any one or more of the technical features of the apparatus 100 may be combined with any other one or more of the technical features of the apparatus 100 (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus 100 to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a baby bottle holder being configured to selectively receive, at least in part, and support, at least in part, a baby bottle at a deployed position located proximate to a baby, in which the baby is able to reach the baby bottle in the deployed position, in which a movable baby carriage has a carriage handle, and in which the movable baby carriage is configured to receive and support the baby; and
the baby bottle holder also being configured to selectively attach to, and detach from, the carriage handle of the movable baby carriage at a storage position, in which the storage position is spaced apart from the deployed position; and
wherein the baby bottle holder, in use, remains positioned away from the reach of the baby who is positioned in the movable baby carriage once the baby bottle holder is selectively attached to the carriage handle of the movable baby carriage at the storage position.

2. An apparatus, comprising:
a baby bottle holder, including:
a resiliently deformable body being configured to selectively receive, at least in part, and support, at least in part, a baby bottle at a deployed position located proximate to a baby, in which the baby is able to reach the baby bottle in the deployed position, in which a movable baby carriage has a carriage handle, and in which the movable baby carriage is configured to receive and support the baby; and
the resiliently deformable body also being configured to selectively attach to, and detach from, the carriage handle of the movable baby carriage at a storage position, in which the storage position is spaced apart from the deployed position; and
wherein the resiliently deformable body, in use, remains positioned away from the reach of the baby who is positioned in the movable baby carriage once the resiliently deformable body is selectively attached to the carriage handle of the movable baby carriage at the storage position.

3. The apparatus of claim 2, wherein:
the resiliently deformable body is further configured to provide a first elongated channel; and
the first elongated channel is configured to selectively receive, at least in part, the baby bottle at the deployed position.

4. The apparatus of claim 2, wherein:
the resiliently deformable body is further configured to provide, at least in part, a second elongated channel; and
the second elongated channel is configured to selectively frictionally attach, at least in part, to the carriage handle of the movable baby carriage at the storage position.

5. The apparatus of claim 2, wherein:
the resiliently deformable body is further configured to be resiliently deformable, at least in part, in such a way that:
the resiliently deformable body, in use, selectively frictionally receives, at least in part, the baby bottle; and
the resiliently deformable body, in use, positions the baby bottle once the resiliently deformable body is positioned proximate to the baby who is positioned in the movable baby carriage at the deployed position.

6. The apparatus of claim 2, wherein:
the resiliently deformable body is further configured to provide a first elongated channel; and
the first elongated channel is configured to selectively receive, at least in part, the baby bottle at the deployed position; and
the resiliently deformable body is further configured to provide, at least in part, a second elongated channel that is spaced apart from the first elongated channel; and
the second elongated channel is configured to selectively frictionally attach, at least in part, to the carriage handle of the movable baby carriage at the storage position.

7. The apparatus of claim 2, wherein:
the resiliently deformable body is further configured to securely receive, at least in part, a baby bottle cap of the baby bottle.

8. The apparatus of claim 2, wherein:
the resiliently deformable body provides an end portion configured to selectively receive, at least in part, a baby bottle cap.

9. The apparatus of claim 2, wherein:
the resiliently deformable body provides an end portion configured to selectively receive, at least in part, and frictionally fit with, at least in part, a baby bottle cap.

10. The apparatus of claim 2, wherein:
the resiliently deformable body is further configured to provide, at least in part, a second elongated channel; and
the second elongated channel is configured to securely receive, at least in part, a baby bottle cap of the baby bottle.

11. The apparatus of claim 2, wherein:
the resiliently deformable body is further configured to provide, at least in part, a second elongated channel; and
the second elongated channel is configured to friction fit, at least in part, with a baby bottle cap of the baby bottle.

12. The apparatus of claim 2, wherein:
the resiliently deformable body has an elongated length extending between opposite side portions.

13. The apparatus of claim 2, wherein:
the resiliently deformable body is further configured to provide a first elongated channel; and
the first elongated channel is positioned between opposite side portions of the resiliently deformable body.

14. The apparatus of claim 2, wherein:
the resiliently deformable body is further configured to provide a first elongated channel; and
the first elongated channel forms a U-shaped formation having opposite side walls configured to frictionally engage the baby bottle in which the baby bottle is insertable into the first elongated channel, and the opposite side walls, in use, resiliently spread apart and frictionally engage the baby bottle in a secure arrangement.

15. The apparatus of claim 2, wherein:
the resiliently deformable body is further configured to provide, at least in part, a second elongated channel; and
the second elongated channel extends between opposite side portions of the resiliently deformable body.

16. The apparatus of claim 2, wherein:
the resiliently deformable body is further configured to provide, at least in part, a second elongated channel; and
the second elongated channel forms a U-shaped formation having opposite side walls configured to selectively frictionally engage the carriage handle.

17. The apparatus of claim 2, wherein:
the resiliently deformable body is further configured to provide, at least in part, a second elongated channel; and
the resiliently deformable body is further configured to securely receive, at least in part, a baby bottle cap of the baby bottle; and
the second elongated channel is further configured to form a U-shaped formation having opposite side walls configured to selectively frictionally engage the carriage handle and the baby bottle cap.

18. The apparatus of claim 2, wherein:
the resiliently deformable body is further configured to provide, at least in part, a second elongated channel; and
the resiliently deformable body is further configured to provide a first elongated channel; and
the first elongated channel and the second elongated channel intersect each other.

19. The apparatus of claim 2, wherein:
the resiliently deformable body is further configured to provide a first elongated channel; and
the resiliently deformable body is further configured to provide, at least in part, a second elongated channel; and
the first elongated channel and the second elongated channel are aligned orthogonally relative to each other.

20. An apparatus, comprising:
a movable baby carriage having a carriage handle, in which the movable baby carriage is configured to receive and support a baby; and
a baby bottle holder, including:
a resiliently deformable body being configured to selectively receive, at least in part, and support, at least in part, a baby bottle at a deployed position located proximate to the baby, in which the baby is able to reach the baby bottle in the deployed position; and
the resiliently deformable body also being configured to selectively attach to, and detach from, the carriage handle of the movable baby carriage at a storage position, in which the storage position is spaced apart from the deployed position; and
wherein the resiliently deformable body, in use, remains positioned away from the reach of the baby who is positioned in the movable baby carriage once the resiliently deformable body is selectively attached to the carriage handle of the movable baby carriage at the storage position.
